(19) United States
(12) Patent Application Publication
(10) Pub. No.: US 2008/0225673 A1
(43) Pub. Date: Sep. 18, 2008

(54) Information recording device and head

(75) Inventors: Shinya Hasegawa, Kawasaki (JP); Keiji Aruga, Kawasaki (JP); Fumihiro Tawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,585

(22) Filed: Feb. 22, 2008

Related U.S. Application Data
(63) Continuation of application No. PCT/JP2005/015571, filed on Aug. 26, 2005.

(51) Int. Cl. G11B 7/00

(52) U.S. Cl. 369/112.23; 369/112.01

(57) ABSTRACT

In a magnetic recording device, a semiconductor laser (LD) is disposed at a position with a predetermined distance from a swing arm having a slider. The laser beam output from the LD is irradiated, via a beam converter and a mirror, to a spherical aberration lens that generates spherical aberration. The laser beam transmitted through the spherical aberration lens is directed to a light incident opening of the slider at a constant angle (perpendicularly), and then to a position of a recording medium at which information is recorded, thereby performing thermal assist at the magnetic recording time.

### BACKGROUND OF THE INVENTION

1. Field of the Invention

The present invention relates to an information recording device that records information onto a recording medium, by controlling an arm installed with a head which records information onto the recording medium. Particularly, the present invention relates to an information recording device and a head, capable of performing high-speed recording and high-speed reproduction of information onto and from the recording medium, by solving a problem of thermal fluctuation occurring on a magnetic disk due to high recording density of the magnetic disk.

2. Description of the Related Art

Recently, along the increase in the capacity of a magnetic disk device in a computer, recording density of a recording medium onto which information is recorded has increased. The magnetic disk device performs writing and reading of information onto and from a recording medium, using a magnetic head. FIG. 19 depicts an outline of the magnetic disk device. As shown in FIG. 19, this magnetic disk device rotates a swing arm attached with a slider, to perform recording and reproduction of information. This swing arm has light weight and a small size, and can perform high-speed seek, high-speed recording and high-speed reproduction.

The head that performs recording and reproduction of information is explained below. FIG. 20 depicts a configuration of a head called a single-pole-type perpendicular (or vertical) recording head. This head is manufactured according to a thin-film manufacturing technique being combined with lithography. In the actual magnetic disk device, this head is manufactured at a part of a chip of about 1-millimeter square, called a slider, having a pad structure for surfacing or floating.

The head has a main magnetic pole and an auxiliary magnetic pole. In FIG. 20, a rectangular-solid larger magnetic pole is the auxiliary magnetic pole for feeding back a magnetic flux, and a tapered small magnetic pole is the main magnetic pole. Coils are wound around the auxiliary magnetic pole and the main magnetic pole. By tapering the main magnetic pole, the magnetic field is concentrated on a recording portion, to generate a recording magnetic field. On the other hand, the auxiliary magnetic pole picks up the magnetic flux generated by the main magnetic flux, and returns the picked-up magnetic flux to the coils and the main magnetic pole again. A metal member that is called a lower shield, similar to a magnetic-pole, is located at the backside of the auxiliary magnetic pole. A magnetic resistance element (such as a magneto-resistive effect (MR) element, a giant magneto-resistive effect (GMR) element, and a tunnel magneto-resistive effect (TMR) element) is disposed in a gap between the lower shield and the auxiliary magnetic pole, thereby forming a reproduction magnetic head.

The main magnetic pole records information onto the recording medium, as an independent pole (single pole) corresponding to the N pole or the S pole of a magnet. Therefore, the main magnetic pole is called a single-pole head or single-pole-type perpendicular (or vertical) recording head (hereinafter, simply “single-pole head”). In recording information using the single-pole head, the main magnetic pole generates a magnetic field, and records information onto the recording medium having a recording film. A thin film of a hard-magnetic metal such as tellurium (Te), ferrum <iron> (Fe) and cobalt (Co) can be used as a recording film, in addition to cobalt (Co) and platinum (Pt) that are typically used as a magnetic disk material. This recording film becomes a magnetic recording layer. When this magnetic recording layer is superimposed on a soft-magnetic thin film such as permalloy, a recording medium for perpendicular recording is obtained. This recording medium is laid out near the single-pole head, and the recording medium is rotated to an arrowhead direction as indicated in FIG. 20, thereby recording information.

To increase the recording capacity per unit area of a recording medium such as a magnetic disk, areal recording density needs to be high. Along the increase in the recording density, the recording area per bit (bit size) becomes smaller on the recording medium. When the bit size becomes smaller, what is called thermal demagnetization occurs so that energy held by one bit information becomes close to the thermal energy at room temperature, and rerecorded magnetized information is inverted or disappears due to thermal fluctuation.

That is, when the bit size is reduced to increase the recording density, magnetic particles need to be minute. To solve the problem of thermal fluctuation, a ratio of Ku×V to kT needs to be equal to or higher than 60, where V represents a volume of minute magnetic particles, Ku represents an anisotropy constant, and kT represents energy at a temperature when the problem of thermal fluctuation occurs.

To set the ratio of Ku×V to kT equal to or higher than 60, Ku needs to be large. However, to set Ku large, the magnetic field used to record information onto the recording medium needs to be large. Because the magnetic recording head that generates the large magnetic field cannot be realized, it becomes difficult to increase the capacity of the recording medium.

Accordingly, a method of combining the magnetic recording system with a thermal-assist recording system has been proposed. The thermal assist system means heating of a medium by irradiating light. To use a recording medium having a high Ku, that is, a high coercivity, a light beam is locally irradiated to near the recording position to heat this position, and the coercivity of the heated part is lowered to be equal to or below that of the achievable recording magnetic field. With this arrangement, magnetic recording can be performed using the magnetic recording head.

The specification of Japanese Patent Application No. H9-326939 discloses this kind of a thermal-assist optical system. As shown in FIG. 21, a mirror and a lens are fixed onto a swing arm. A laser beam output from a semiconductor laser (hereinafter, LD) is supplementarily irradiated onto an information recording position of the recording medium, using a magnetic field according to an air-core coil, thereby performing recording. In this example, this technique is applied to a magneto-optical disk(MO).

Similarly, Japanese Patent Application Laid-open No. 2001-34982 discloses a technique of laying out an optical system including an LD on a swing arm. Japanese Patent Application Laid-open No. 2002-298302 discloses a technique of performing magnetic recording by conducting a thermal assist irradiating a laser beam to the recording medium using an optical fiber.

Japanese Patent Application Laid-open No. H6-131738 discloses a technique of performing magnetic recording by irradiating a laser beam onto a recording medium using a linear actuator, in a case of a magneto-optical disk device.

However, according to these conventional techniques, the optical system or the optical fiber is laid out on the swing arm, to irradiate the thermal-assist laser beam onto the recording medium. Therefore, this causes a problem that the swing arm becomes heavy.

When the swing arm becomes heavy, the advantage of the magnetic disk device cannot be obtained, that is, the swing arm cannot achieve high-speed seek of information to perform high-speed recording or high-speed reproduction of information.

Instead of the swing arm, the linear actuator can be installed in the magnetic disk device. However, to design a new magnetic disk device using the linear actuator is very difficult, and this is not realistic from the viewpoint of designing time and designing cost. Further, the access speed becomes considerably slow, and the high-speed access performance of the magnetic disk is lost.

Therefore, it is highly important to solve the problem of thermal fluctuation generated in the recording medium such as the magnetic disk, by performing thermal assist through irradiation of laser beams to the recording medium to record information, without losing advantages of the conventional magnetic disk device.

### SUMMARY OF THE INVENTION

It is an object of the present invention to at least partially solve the problems in the conventional technology.

According to an aspect of the present invention, an information recording device that records information on a recording medium, by positioning a rotatable arm having a head mounted thereon for recording the information on the recording medium, the information recording device includes a light input unit, disposed at a stationary position other than a position of the rotatable arm, inputting light to the head; and an irradiating unit irradiating a position of the recording medium at which information is recorded with the light incident to the head from the light input unit.

According to another aspect of the present invention, a head for recording information on a recording medium, includes a reflection surface member that reflects incident light; and a light transmitting unit that brings the light reflected by the reflection surface member, to a position of the recording medium at which information is recorded.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a top plan view of a magnetic disk device according to an embodiment of the present invention;

FIG. 2 is a graph expressing ideal beams which are incident perpendicularly to a light incident opening on a side surface of a slider, at different rotation angles of a swing arm shown in FIG. 1;

FIG. 3 depicts a configuration of the magnetic disk device that generates the beams shown in FIG. 2;

FIG. 4 is a graph expressing positional deviations between positions of a laser beam emitted from an LD and positions of an optical axis reference (this optical axis reference corresponds to the light incident opening) of a slider, at different rotation angles of the swing arm shown in FIG. 3;

FIG. 5A depicts-a diffraction image (when the slider rotation angle is 0 degree) on a light incident opening when the lens opening has a size of 0.5 millimeter in the X direction and 0.2 millimeter in the Y direction;

FIG. 5B depicts a diffraction image (when the slider rotation angle is 8 degrees) on a light incident opening when the lens opening has a size of 0.5 millimeter in the X direction and 0.2 millimeter in the Y direction;

FIG. 5C depicts a diffraction image (when the slider rotation angle is 16 degrees) on a light incident opening when the lens opening has a size of 0.5 millimeter in the X direction and 0.2 millimeter in the Y direction;

FIG. 6A depicts a state that a beam splitter divides a laser beam from the LD, and inputs the divided laser beams to sliders;

FIG. 6B depicts a state that an expansion lens expands laser beams from the LD, and inputs the laser beams to sliders;

FIG. 7 is an example of a state that a laser beam is input to a slider of each platter, using a Micro Electro Mechanical System (MEMS) mirror by single-axis scanning;

FIG. 8 depicts a magnetic disk device capable of realizing a capacity of 400 to 500 Gb/in² using this optical system;

FIG. 9A depicts a configuration of a magnetic disk device that scans a laser beam in the X direction or in the Y direction;

FIG. 9B depicts the configuration of a magnetic disk device that scans a laser beam in the X direction or in the Y direction;

FIG. 10 is a schematic diagram for explaining an optical unit that changes over between laser beams, using a liquid crystal;

FIGS. 11A and 11B depict examples of a spherical aberration lens including a reflection surface;

FIG. 12 depicts a configuration of a head unit of the magnetic disk device according to the embodiment;

FIGS. 13A, 13B and 13C depict a detailed configuration of the head unit shown in FIG. 12;

FIG. 14 is a schematic diagram for explaining a method of manufacturing the head unit shown in FIGS. 12, 13A, 13B and 13C;

FIG. 15 is another schematic diagram for explaining the method of manufacturing the head unit shown in FIGS. 12, 13A, 13B and 13C;

FIG. 16 depicts a configuration of the head unit using a diffractive optical element;

FIGS. 17A, 17B and 17C depict a detailed configuration of the head unit shown in FIG. 16;

FIG. 18 is a schematic diagram for explaining a method of manufacturing the head unit shown in FIGS. 16, 17A, 17B and 17C;

FIG. 19 depicts an outline of the magnetic disk device;

FIG. 20 depicts a configuration of a head called a single-pole-type perpendicular recording head; and

FIG. 21 is a schematic diagram for explaining a conventional technique.

### DETAILED DESCRIPTION OF THE PREFERRED EMBODIMENTS

Exemplary embodiments of an information recording device according to the present invention will be explained below in detail with reference to the accompanying drawings. These embodiments do not limit the present invention.

In the present embodiment, the magnetic disk device is explained as an example of an information recording device. First, characteristics of a magnetic disk device according to the present invention are explained. In the information recording device according to the present invention, a semiconductor laser diode (hereinafter, LD) that outputs a laser beam to perform a thermal assist is laid out at a stationary position in the magnetic disk device, other than a magnetic recording medium and a swing arm having a head for performing recording and reproduction of information onto and from the magnetic recording medium.

When the magnetic disk device records information onto the magnetic recording medium, the LD emits a laser beam toward the light incident opening of the head (the light incident opening of the head is described later). The light incident to the head is irradiated onto the magnetic recording medium, thereby magnetically recording information at a position where the laser beam is irradiated.

As explained above, in the magnetic disk device according to the present invention, the LD is laid out at a position other than the swing arm. A laser beam is emitted to the light incident opening of the head from the laid-out position of the LD, thereby performing a thermal assist at the information recording time. Therefore, the LD and the electric wiring of the LD do not need to be set on the swing arm. The problem of thermal fluctuation can be solved, without losing the existing advantage of the magnetic disk device, that is, without losing high-speed recording and reproduction performance based on high-speed seek.

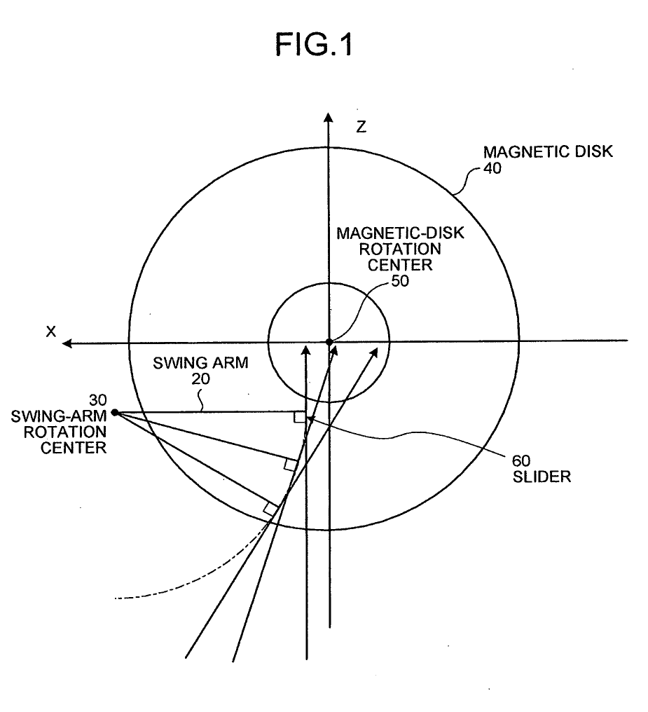

The magnetic disk device according to the present embodiment is explained in detail below. FIG. 1 depicts a top plan view of the magnetic disk device according to the embodiment. In the magnetic disk device, in irradiating a laser beam to the light incident opening of a slider 60 from a stationary position of an LD (not shown), the LD preferably irradiates the laser beam to a side surface of the slider 60 mounted on a swing arm 20 capable of rotating about a swing-arm rotation center 30.

In inputting light to the slider 60 from the LD, the magnetic disk device preferably inputs light, at a constant angle, to the light incident opening provided on the side surface of the slider 60, at any rotation angle of the slider 60, from the viewpoint of maintaining the characteristics of the optical system after the light is incident to the light incident opening. While various angles are considered for inputting light to the slider 60, it is most preferable to input light at a right angle to a head, i.e. perpendicularly to the side surface of the slider 60, from the viewpoint of space within the magnetic disk device, design of the optical system, and easiness of manufacturing the slider 60.

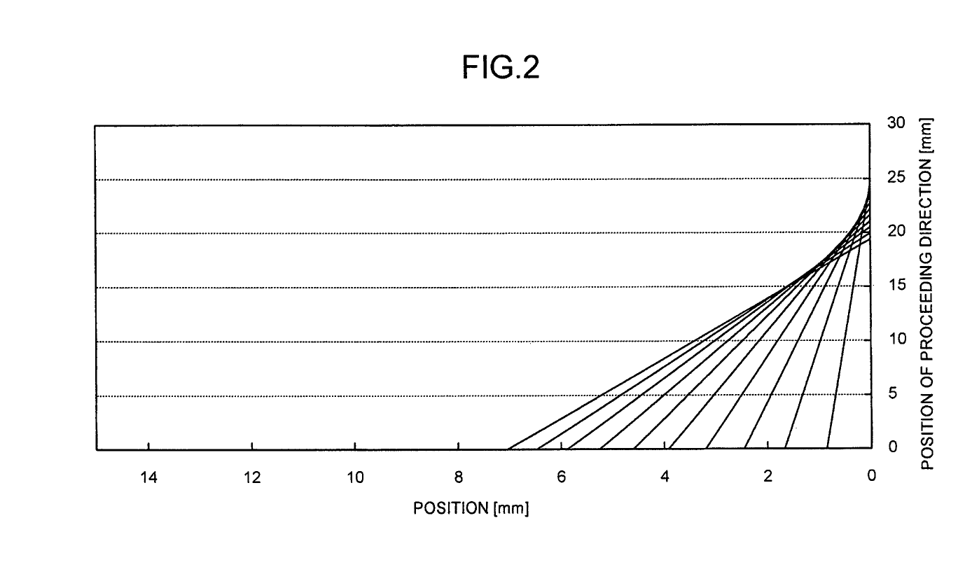

However, when a laser beam is simply emitted from the LD to the slider 60, it is not possible to secure the condition that the laser beam is always perpendicularly incident to the side surface of the slider 60, at any rotation angle of the swing arm 20. FIG. 2 is a graph expressing ideal beams which are incident perpendicularly to the light incident opening on the side surface of the slider, at different rotation angles of the swing arm 20 shown in FIG. 1.

The beams shown in FIG. 2 are assumed as follows, based on the actual magnetic disk device. A distance from a rotation center 30 of the swing arm 20 to the light incident opening of the slider 60 is 32 millimeters. The slider 60 rotates within a range of a radius of a magnetic disk 40 from its rotation center 50, from 17 millimeters to 30 millimeters. When the slider 60 is at the innermost periphery, a distance of a beam perpendicular to the side surface of the slider 60, from the light incident opening to the outer periphery of the disk is set to 25 millimeters. The horizontal axis of FIG. 2 expresses a position in the X axis direction in FIG. 1, perpendicular to the beam, with the position of the beam in the X direction as 0 millimeter. A disk radius is assumed to be 35 millimeters, at a position outside the disk. In the present invention, the beams shown in FIG. 2 are generated using aberration of the optical system.

A method of generating the beams shown in FIG. 2 using the aberration of the optical system is explained. Specifically, in the present embodiment, spherical aberration of the optical system is utilized to generate the beams shown in FIG. 2. The position of the slider 60 when the swing arm 20 is at the innermost periphery is considered as the optical axis center of the optical system. Aberration that the focal point of the beam comes closer to the optical axis center when the slider 60 moves far from the rotation center 50 of the magnetic disk 40 is used.

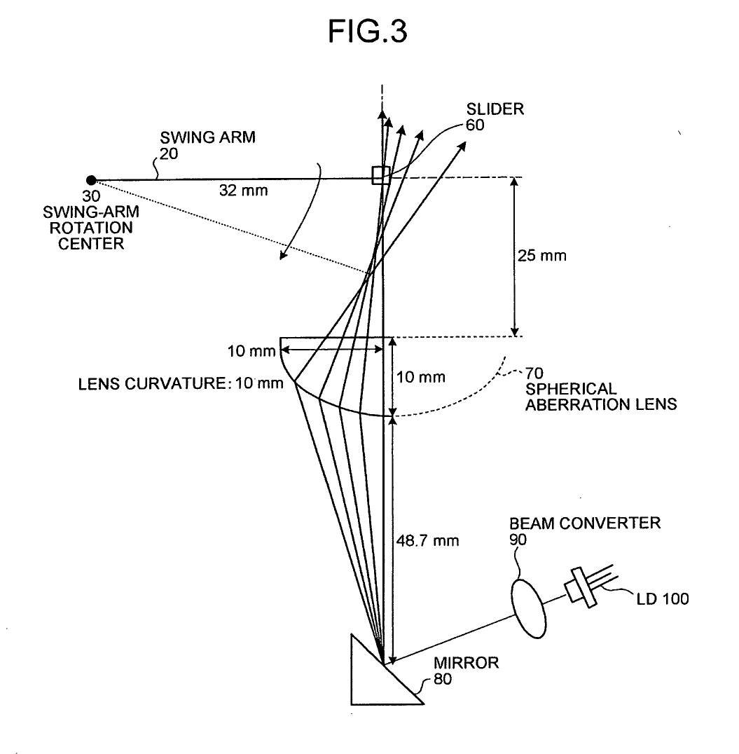

FIG. 3 depicts a configuration of the magnetic disk device that generates the beams indicated in FIG. 2. As shown in FIG. 3, this magnetic disk device includes the swing arm 20, the slider 60, a spherical aberration lens 70, a mirror 80, a beam converter 90, and an LD 100. As shown in FIG. 3, the beam converter 90 including a collimator lens and a cylindrical lens once narrows down a laser beam emitted from the LD 100, and inputs the beam to the mirror 80. The laser beam is reflected by the mirror 80, and is irradiated to the light incident opening of the slider 60 via the spherical aberration lens 70.

A set value of the spherical aberration lens 70 that generates the spherical aberration of the optical system can be expressed by the expression of an aspherical lens as follows:

$$Z = \frac{r}{A} ( 1 - \sqrt{1 - A \cdot \frac{{x}^{2} + {y}^{2}}{{r}^{2}}} ) + {\sum }_{n = 1}^{k} {{C}_{n} ( {x}^{2} + {y}^{2} )}^{n} \qquad ( 1 )$$

where
r=10.0 mm

### A=0.42

### C₁=−0.2913973×10⁻¹⁵

### C₂=−0.8704928×10⁻¹³

### C₃=−0.3561886×10⁻¹¹

### C₄=−0.1349156×10⁻¹¹.

A glass material is BK-7 (refractive index is 1.5222). A wavelength of the laser beam output from the LD 100 is 660 nanometers (the same wavelength as that of the laser beam output from an infrared semiconductor laser for DVD (digital versatile disk) drives). In this expression (1), Z denotes a height of the spherical aberration lens, and variables corresponding to the X axis and the Y axis of the spherical aberration lens are input to x and y. A and C₁ to C₄ denote constants of the aspherical lens (when a thickness of the lens is 10 millimeters), and r denotes a radius of the aspherical lens.

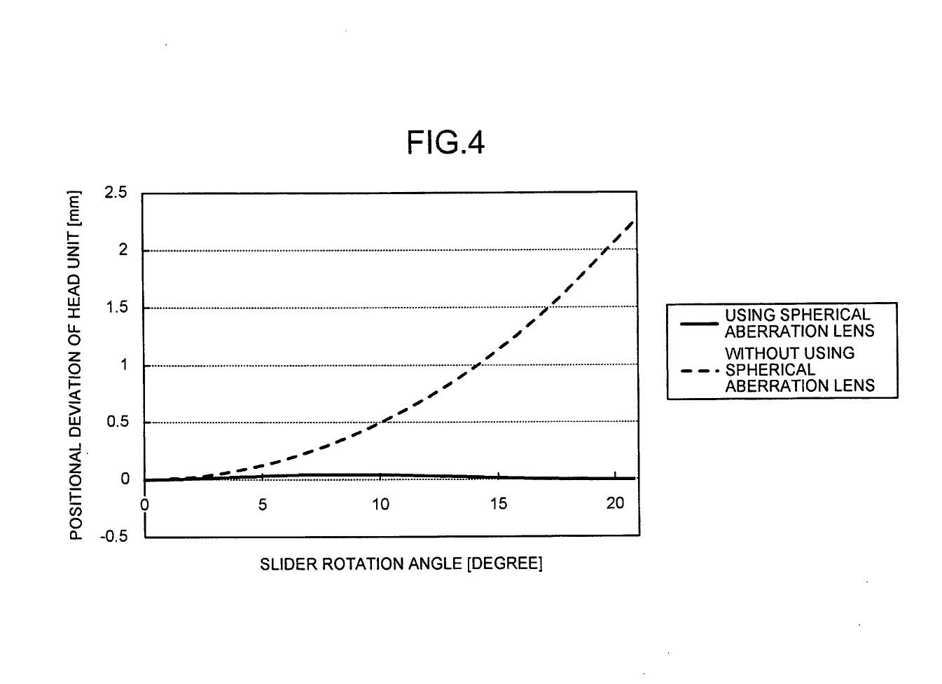

FIG. 4 is a graph expressing a positional deviation between a position of a laser beam emitted from the LD 100 and a position of an optical axis reference (this optical axis reference corresponds to the light incident opening) of the slider 60, at each rotation angle of the swing arm 20 indicated in FIG. 3. The slider rotation angle is defined as an angle toward the external periphery, assuming that the position of the swing arm at the innermost periphery is 0 degree. As shown in FIG. 4, when the spherical aberration lens 70 for generating the spherical aberration of the optical system is used, it can be known that the laser beam is present at substantially an ideal position relative to the light incident opening of the slider 60. On the other hand, when the aspherical aberration lens having no spherical aberration is used, the laser beam is deviated by 2 millimeters or more from the light incident opening, as shown in FIG. 4. Therefore, light intensity can be secured by only a few degrees, and light efficiency at other than the position of the slider 60 at the innermost periphery becomes 0%.

The spherical aberration lens 70 shown in FIG. 3 is used at only one side of the whole lens. Therefore, when the spherical aberration lens 70 is actually manufactured, the spherical lens can be manufactured by mold, and this is preferable from the viewpoint of space saving. A combination of spherical lenses or one spherical lens, not an aspherical lens, can be also used.

The effect of light utilization efficiency concerning the incidence of a laser beam perpendicularly to the light incident opening of the slider 60, at each rotation angle of the swing arm 20 is verified. When the laser beam is irradiated to the whole surface of the spherical aberration lens 70, it is verified that high light-utilization efficiency of 15% is obtained, from light incident to the light incident opening of the slider 60, as follows.

What level of the laser beam transmitted through the spherical aberration lens 70 is incident to the light incident opening of the slider 60, at each rotation angle of the swing arm 20 is expressed by calculation. The size of the light incident opening of the slider 60 in the peripheral direction is set as 100 micrometers, and the size in the perpendicular direction is set as 100 micrometers.

A maximum permissible opening is virtually set in front of the spherical aberration lens 70 so that the size of this opening becomes equal to or smaller than the size (100 micrometers in both the spherical direction and the perpendicular direction, respectively) of the light incident opening provided on the slider 60, at each rotation angle of the swing arm 20. This virtual opening is denoted below as the opening of the spherical aberration lens 70.

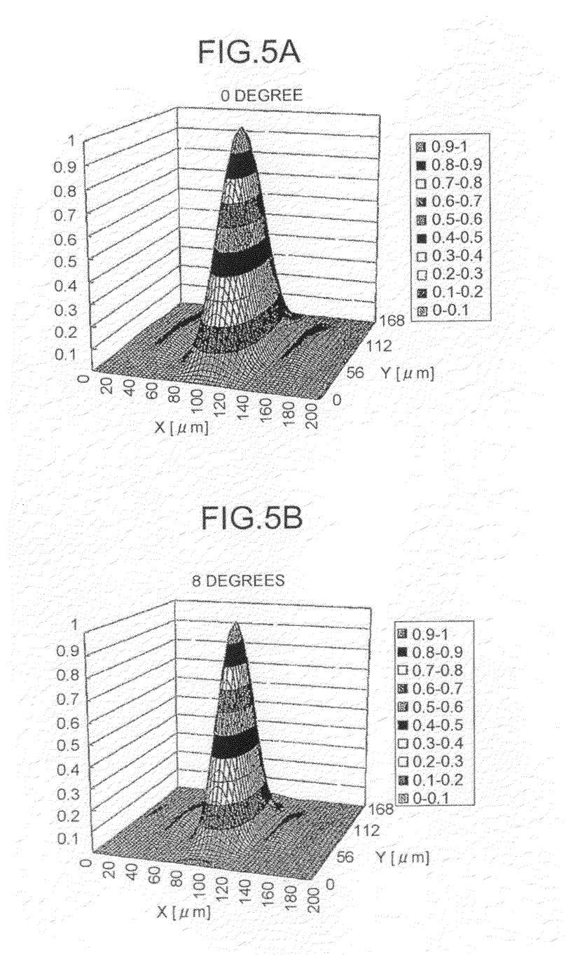

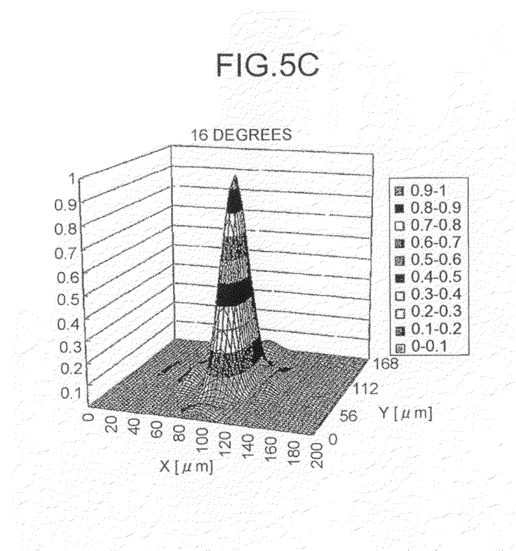

The opening of the spherical aberration lens 70 moves corresponding to each position of the rotation angle of the slider 60. FIG. 5A, FIG. 5B, and FIG. 5C depict diffraction images (when the slider rotation angle is 0 degree, 8 degrees, and 16 degrees, respectively) on a light collection surface when the opening of the spherical aberration lens 70 has sizes of 0.5 millimeter in the X direction and 0.2 millimeter in the Y direction. The light collection surface is the surface that received a beam within the slider.

As shown in FIG. 5A, FIG. 5B, and FIG. 5C, it can be known that each diffraction image has a beam size of 80 micrometers at each rotation angle of the slider 60. Therefore, when a laser beam is input by the mirror 80 to the spherical aberration lens 70 shown in FIG. 3 by scanning in a direction parallel with the surface of the recording medium, the diffraction image has a beam size of 80 micrometers, at any slider position, when the size of the opening of the laser beam incident to the spherical aberration lens 70 is set to 0.5 millimeter in the X direction and 0.2 millimeter in the Y direction. Strictly speaking, the beam size becomes when the rotation angle becomes larger, that is, toward the spherical aberration lens. This is because the F number of the beam becomes smaller. Therefore, the F number is preferably set such that the beam size concerning the light utilization efficiency becomes a desired beam diameter at the innermost periphery where the disk rotation angle is 0 degree. When the beam diameter is smaller than the size of the incident opening, the beam diameter is smaller at any rotation angle, and there is no loss of light intensity.

When the opening of the spherical aberration lens 70 is the whole surface of the lens and also when a laser beam is irradiated to the whole surface of the spherical aberration lens 70, the calculation of the intensity ratio of light input to the light incident opening (100 micrometers square) at each rotation position of the slider 60 indicates that the light can be taken in at the light utilization efficiency of 15% at each position of the slider 60. Depending on the design method of the spherical aberration lens 70, the light utilization ratio can be increased to 30%.

While the position of the slider 60 at the innermost periphery of the swing arm 20 is the light axis center of the spherical aberration of the optical system in the above example, the position of the slider 60 is not limited to this example. The position of the slider 60 at the outermost periphery of the swing arm 20 can be considered as the light axis center of the spherical aberration. In this case, a spherical aberration lens that generates the aberration that the focal point becomes far from the light axis center when the slider 60 moves toward the inner periphery can be also used.

The magnetic disk device has plural magnetic disks (platters), and performs magnetic recording onto the front surface or the back surface of each magnetic disk. Therefore, a laser beam needs to be irradiated to each surface of the magnetic disk onto which information is to be magnetically recorded.

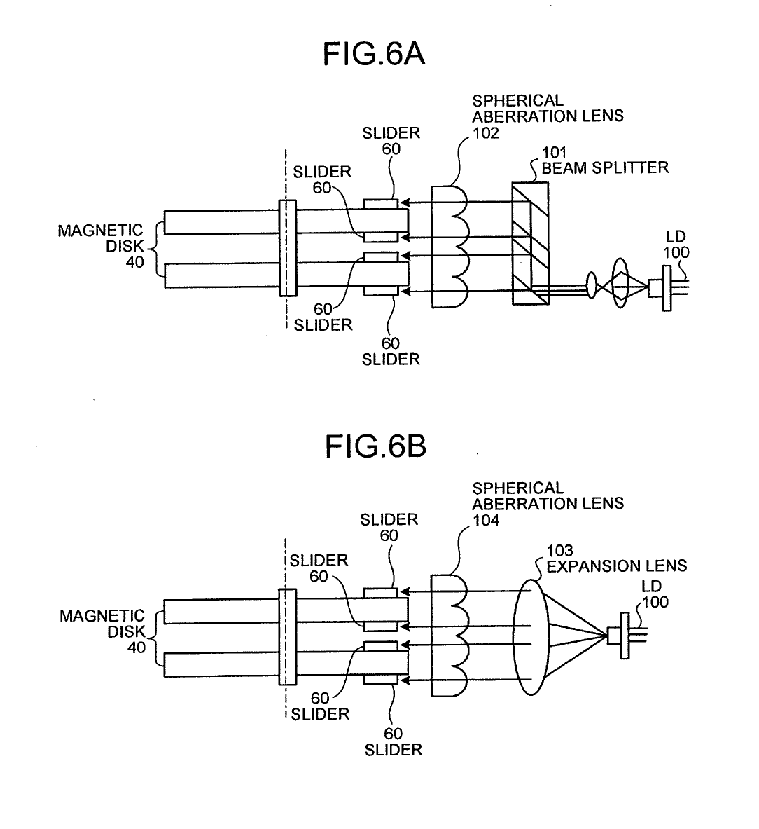

Regarding the irradiation of a laser beam, when the laser intensity is high, a laser beam can be irradiated simultaneously to each recording surface, when plural platters, for example, two platters, having four recording surfaces, are used. FIG. 6A depicts a state that a beam splitter 101 divides a laser beam from an LD 100, and inputs the divided laser beams to the sliders 60. FIG. 6B depicts a state that an expansion lens 103 expands laser beams from the LD 100, and inputs the laser beams to sliders 60. Spherical aberration lenses 102 and 104 shown in FIG. 6A and FIG. 6B have lenses having the same number of spherical aberration surfaces as the number of the sliders, respectively (in FIG. 6A and FIG. 6B, each spherical aberration lens has four spherical aberration surfaces).

In FIG. 6A and FIG. 6B, a mechanical shutter can be also used to shield a laser beam, to avoid irradiation of the laser beam to a slider to which the laser beam does not need to be input (slider that does not perform magnetic recording). Alternatively, plural LDs can be used for each platter.

As shown in FIG. 6A and FIG. 6B, to increase the number of beams by the number of the front and back surfaces of the platters, the spherical aberration lenses 102 and 104 have a shape that each lens has the same curvature as that of the spherical aberration lens 70 shown in FIG. 3 in the thickness direction of the platters. These aberration lenses can be manufactured at low cost according to the existing molding technique.

As shown in FIG. 6A and FIG. 6B, a movable mirror such as a Micro Electro Mechanical System (MEMS) mirror and a galvano mirror can be used to irradiate a laser beam to the slider of each platter surface, by changing over between optical paths, instead of simultaneously irradiating plural platters.

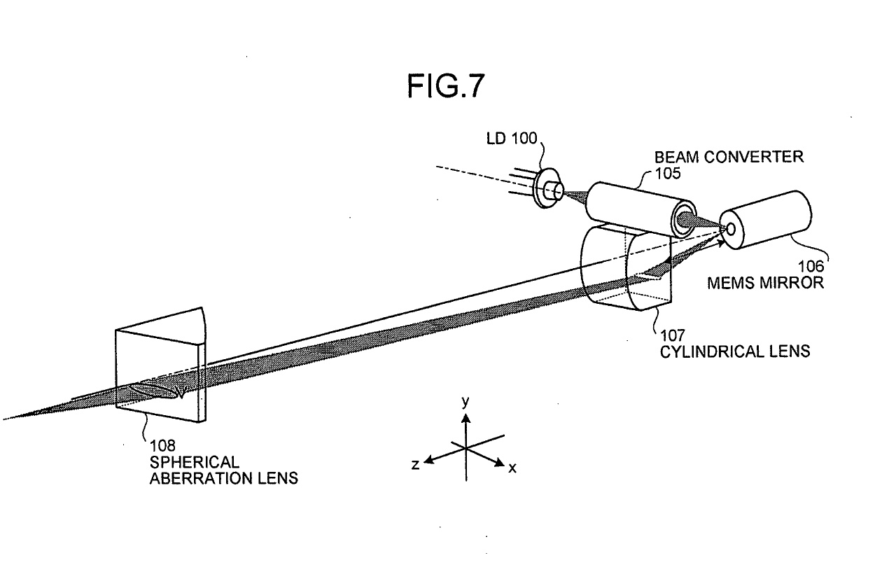

FIG. 7 is one example of a state that a laser beam is input to a slider of each platter, using an MEMS mirror for single-axis scanning. As shown in FIG. 7, a beam converter 105 is used to collect a laser beam output from the LD 100 onto an MEMS mirror 106. The MEMS mirror 106 reflects the laser beam, and inputs the reflected beam to a spherical aberration lens 108 through a cylindrical lens 107.

The cylindrical lens 107 converts a transmitted laser beam in only y direction to a parallel beam. In the present embodiment, the cylindrical lens 107 is laid out with a distance of 10 millimeters from the MEMS mirror 106, and has a center thickness of 4 millimeters and a curvature of 5 millimeters.

When the cylindrical lens 107 is used, even when the MEMS 106 is used to change over the optical path of the laser beam, the laser beam in the y direction becomes a parallel beam parallel with the platter direction, and the laser beam can be input in high precision to the light incident opening of the slider corresponding to each platter. The spherical aberration lens 108 has the same number of curvatures as the number of the spherical aberration lenses shown in FIG. 3.

The light intensity (laser power) used in the present embodiment is explained next. The present invention can be applied to a practical magnetic disk device having capacity about 400 to 500 Gb/in². This capacity is four to five times of the current mainstream magnetic disk capacity, and is a sufficiently attractive value.

Therefore, thermal assist effect can be obtained at about 100° C. which is much lower than about 200° C. to which the temperature is increased using a fine beam spot of a few dozens of nanometers like when the capacity is 1 Tb/in². Therefore, an optical beam of about 1 micrometer can naturally obtain a temperature of about 100° C., and the head unit which irradiates light to the recording medium can be easily manufactured.

To verify the laser power which becomes necessary to record information onto this magnetic recording medium, irradiation conditions are set as follows. A peripheral velocity of the magnetic disk is 42 m/sec. A beam size for thermal assist is 1 micrometer, both in the peripheral direction and in the radius direction. A distance from the center of the light spot to the single magnetic pole of the single-pole head is 2 micrometers.

Sufficient thermal assist effect can be obtained, in the capacity of 400 to 500 Gb/in², by increasing the temperature to 100° C. at a position on the magnetic recording medium corresponding to the single magnetic pole. It is understood by calculation that, to obtain this thermal assist effect, the temperature at the laser-beam irradiation position in front of the position of irradiating a magnetic field from the head needs to be set to 140° C., at the surrounding temperature of 20° C. This temperature once increases at the irradiation position, and thereafter falls to 100° C. at the position of 2 micrometers.

As a result of heat calculation performed based on the above conditions, laser power of 5 milliwatts is necessary, to increase the temperature at the laser-beam irradiation position of the head to 140° C., in a thin-film perpendicular recording layer of a TbFeCo and the like, using glass as a substrate, when the laser-beam size of the used laser beam is 1 micrometer. When a standard LD (having a wavelength of 660 nanometers) used for a DVD-RW is used, an output of about 35 milliwatts is obtained in a direct current. When the light of the LD is irradiated to the whole surface, using the spherical aberration lens, total efficiency to the light incident opening after the light passes the spherical aberration lens is 20%. Therefore, this is a sufficient output, considering the light efficiency of the head unit, and the temperature can be increased to 140° C.

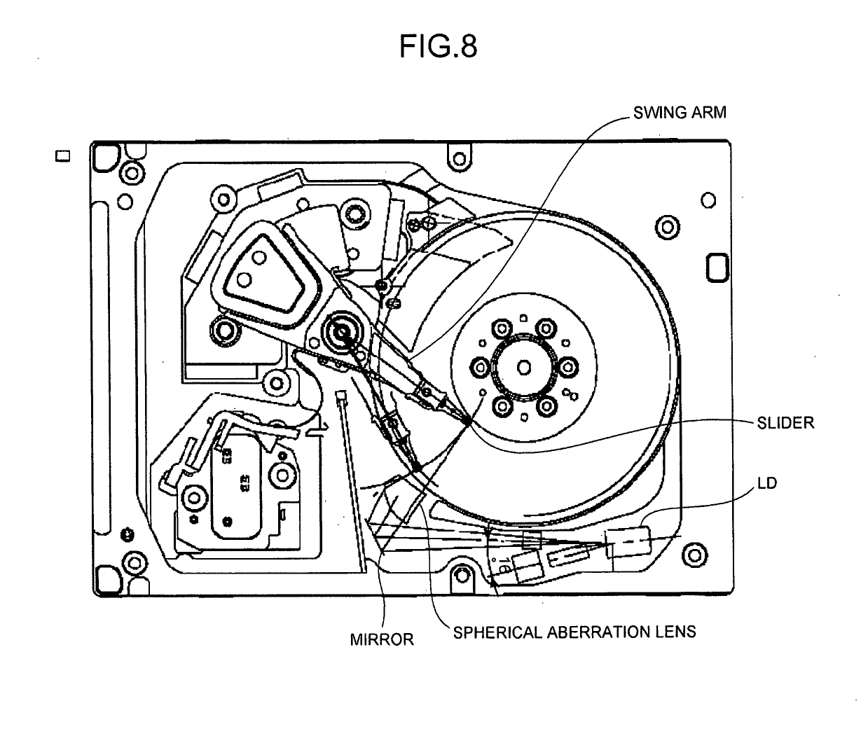

FIG. 8 depicts a magnetic disk device capable of achieving the capacity of 400 to 500 Gb/in², in this optical system. The swing arm of the magnetic disk device shown in FIG. 8 has a radius of 34.8 millimeters. The MEMS performs only one-axis scanning of changing over between the medium surfaces.

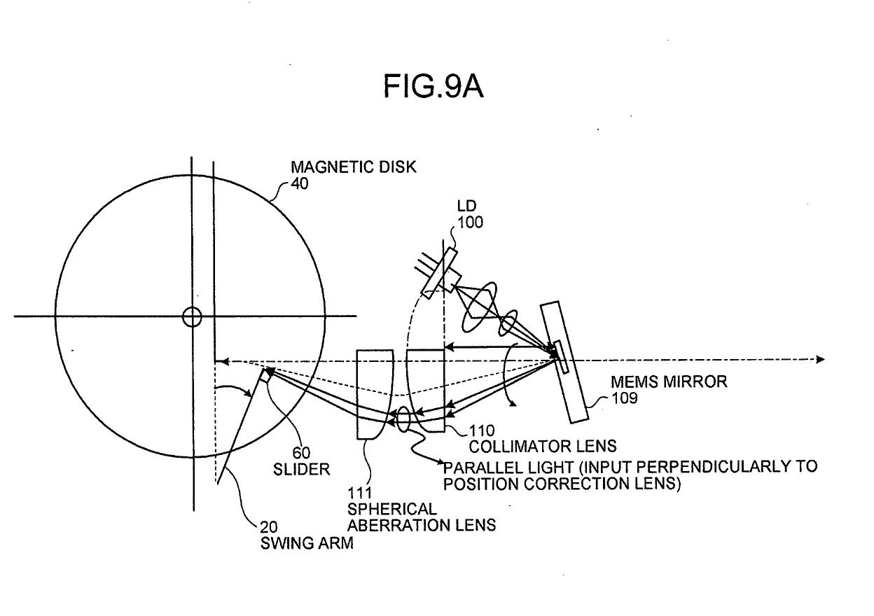

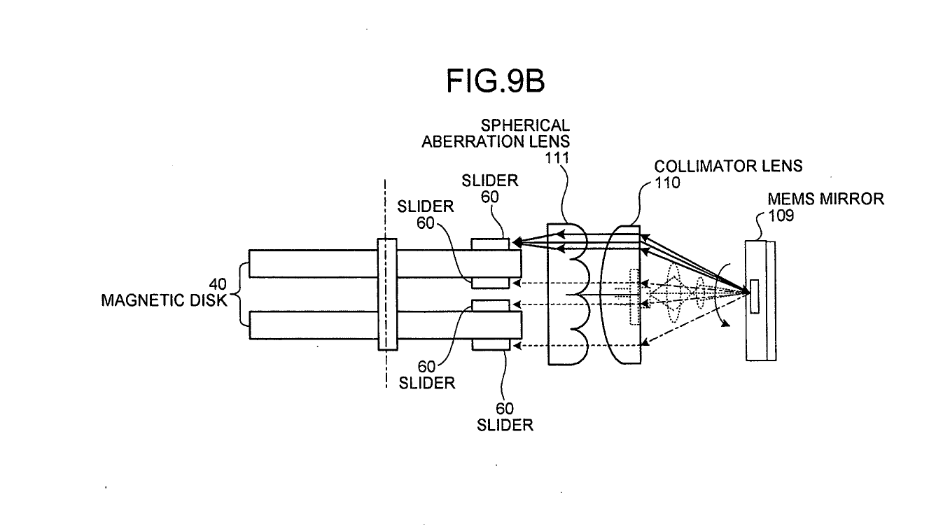

To secure more light intensity of light incident to the slider, the laser beam can be scanned in the X direction or the Y direction, by rotating the MEMS mirror or the like. FIG. 9A and FIG. 9B depict configurations of a magnetic disk device that scans a laser beam in the X direction or in the Y direction.

As shown in FIG. 9A and FIG. 9B, a MEMS mirror 109 reflects a laser beam output from the LD 10, and the reflected laser beam passes a collimator lens 110 and is converted to a parallel beam. The laser beam converted to the parallel beam passes a spherical aberration lens 111, and is incident to the light incident opening of the slider 60. In this case, the sizes of the opening of the spherical aberration lens 70 are set to 0.5 millimeter in the X direction and 0.2 millimeter in the Y direction. As a result, diffraction images as shown in FIG. 5A to FIG. 5C are obtained on the light collection surface within the slider.

In the present embodiment, the MEMS mirror 109 rotates on the surface parallel with the surface of the recording medium, and the rotation of the MEMS mirror 109 is controlled by a controller (not shown). The controller changes the rotation angle of the MEMS mirror 109 so that the laser beam reflected by the MEMS mirror 109 is incident to the light incident surface of the slider 60. The controller has a table defining a relationship between a position at which the information on the magnetic disk is recorded and a rotation angle of the MEMS mirror corresponding to this position. The rotation of the MEMS mirror 109 is controlled using this table.

The controller detects the light intensity of the laser beam reflected from the mirror installed inside the slider 60, and corrects the rotation angle of the MEMS mirror 109 so that the light intensity of the reflected laser beam becomes the maximum.

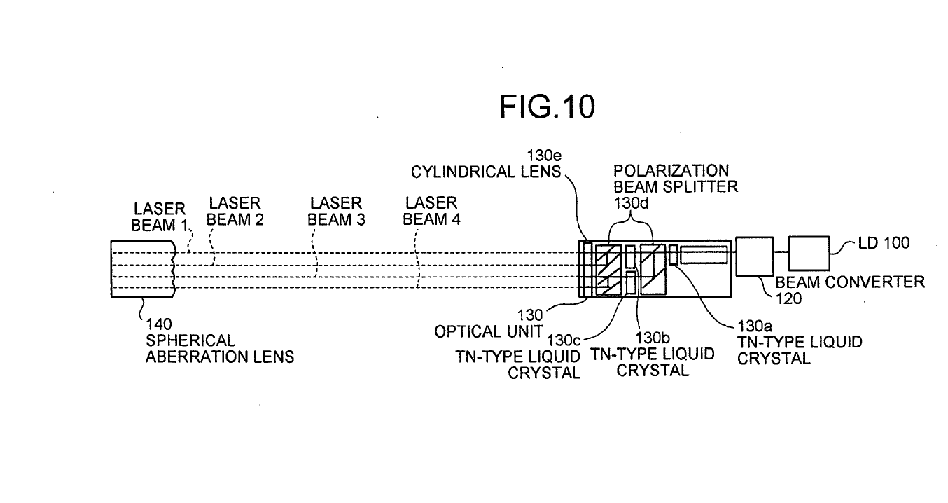

The laser beams can be also changed over by using a crystal liquid device. FIG. 10 is a schematic diagram for explaining an optical unit 130 that changes over between laser beams, using a liquid crystal device. As shown in FIG. 10, a beam converter 120 narrows down a laser beam of the P polarization (direction of the linear polarization of the LD) emitted from the LD 100, and inputs the laser beam to a spherical aberration lens 140 through the optical unit 130. The optical unit 130 changes over between optical paths of the laser beam so that the laser beam is incident to the light incident opening of a desired slider.

The optical unit 130 includes TN-type liquid crystal devices 130a, 130b, 130c, a polarization beam splitter 130d, and a cylindrical lens 130e. The TN-type liquid crystal devices 130a, 130b, 130c can change the polarization direction of the laser beam. Specifically, when the TN-type liquid crystal devices are OFF, laser beams of the P polarization are converted to laser beams of the S polarization. When the TN-type liquid crystal devices are ON, the laser beams remain as the P polarization beams.

The polarization beam splitter 130d transmits the laser beam of the P polarization, and reflects the laser beam of the S polarization. The cylindrical lens 130e converts only the y direction of the transmitted laser beam to a parallel beam. The optical unit 130 changes over the TN-type liquid crystal devices 130a, 130b, 130c between ON and OFF, thereby changing over between the laser beams incident to each slider.

For example, in FIG. 10, when the TN-type liquid crystal device 130a is set to ON and also when the TN-type liquid crystal device 130b is set to OFF, a laser beam 2 is output from the optical unit 130, and laser beams 2 and 3 and a laser beam 4 are not output. In this way, by changing over the TN-type liquid crystal devices 130a, 130b, 130c between ON and OFF, the laser beams 1 to 4 can be nonmechanically changed over.

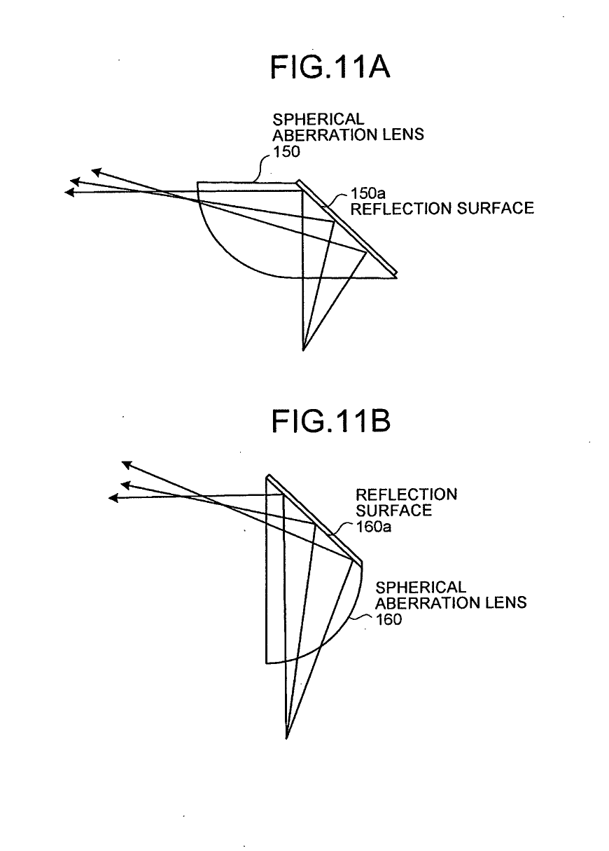

The above spherical aberration lens can include a reflection surface. FIGS. 11A and 11B depict examples of a spherical aberration lens including a reflection surface. As shown in FIGS. 11A and 11B, spherical aberration lenses 150 and 160 include reflection surfaces 150a and 160a, and each reflection surface plays a similar role to that of the mirror 80 shown in FIG. 3. Therefore, a mirror does not need to be installed within the magnetic disk device, and the magnetic disk device can be made compact and can be provided at low cost. In the present embodiment, while a spherical aberration lens is used to generate aberration, aberration can be also generated using a diffractive optical element, instead of the spherical aberration lens.

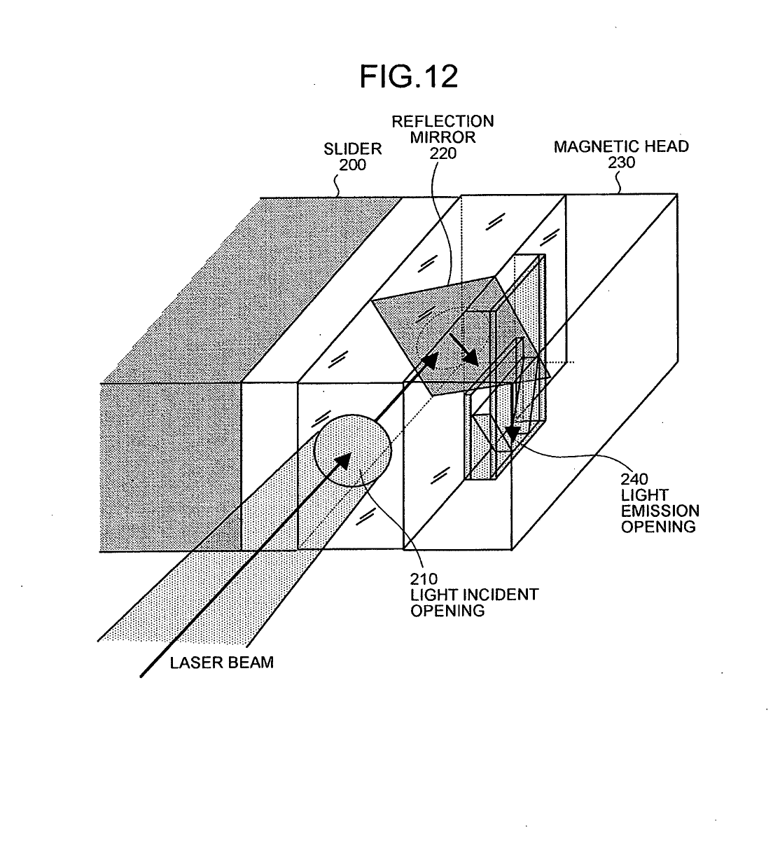

A configuration of the head unit of the magnetic disk device according to the present embodiment is explained next. FIG. 12 depicts the configuration of the head unit of the magnetic disk device according to the present embodiment. As shown in FIG. 12, this head unit includes a slider 200 and a magnetic head 230. The slider 200 has a light incident opening 210 and a, reflection mirror 220. The magnetic head 230 has a light emission opening 240. A laser beam irradiated to the head unit is incident to the head from the light incident opening 210, and is reflected from the reflection mirror 220. The laser beam reflected from the reflection mirror 220 is designed to have a beam diameter of 80 micrometers. Thereafter, the laser beam is emitted from the light emission opening 240, thereby performing thermal assist at the information recording time.

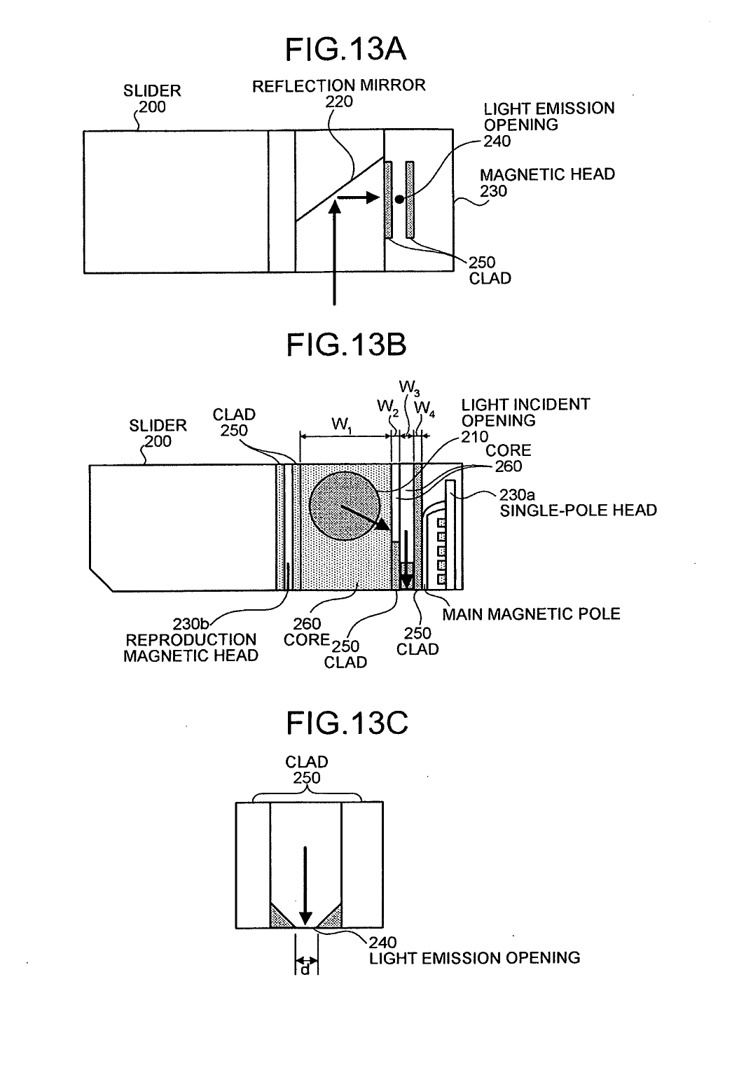

The laser beam reflected by the reflection mirror 220 passes a core (Ta₂O₅) 260, and is irradiated from the light emission opening 240, through the core 260 within both clads 250 (see FIGS. 13A-13C).

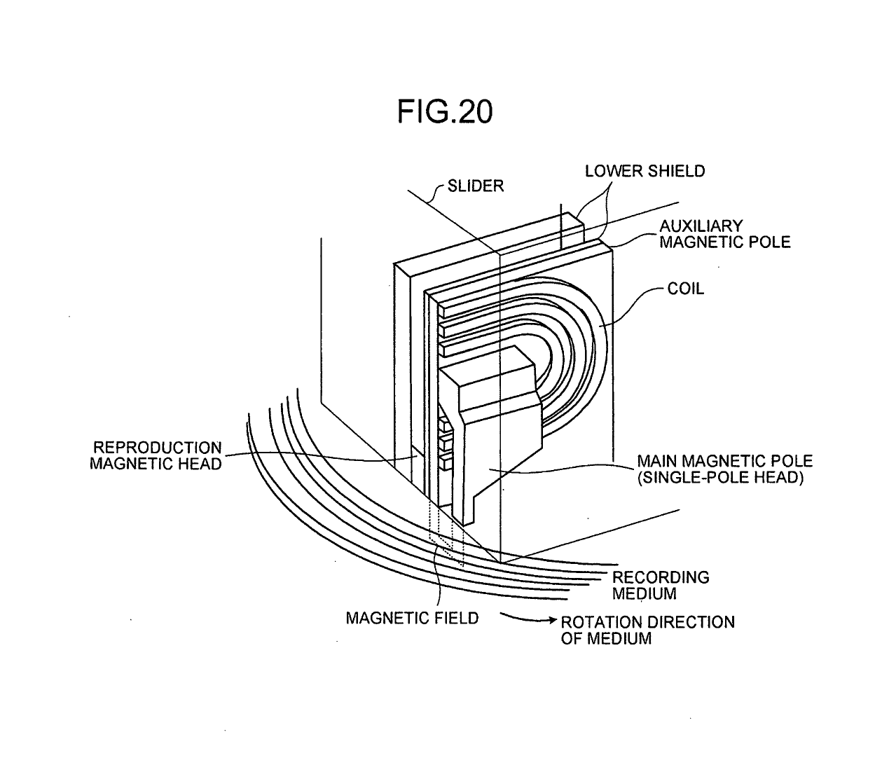

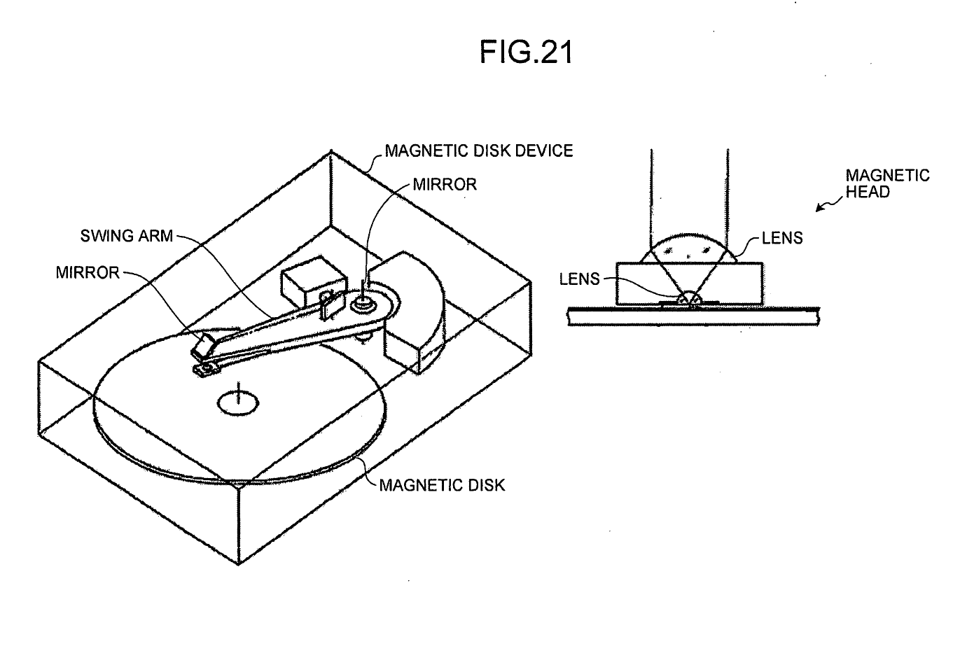

FIGS. 13A, 13B and 13C depict a detailed configuration of the head unit shown in FIG. 12. As shown in FIG. 12, the magnetic head 230 has a single-pole head 230a, and a reproduction magnetic head 230b. The single-pole head 230a generates a magnetic flux, and records information onto a magnetic disk. The reproduction magnetic head 230b reproduces information recorded on the magnetic disk. The magnetic head unit faces a direction opposite to that of the magnetic head shown in FIG. 20. That is, a part near to the slider is the main magnetic pole. This is because it is desirable to set the light irradiation position close to the position of the main magnetic pole. While the reproduction magnetic head is set at the left side of the reflection mirror, the reproduction magnetic head does not need to be set in this arrangement.

The laser beam reflected by the reflection mirror 220 passes the core (Ta₂O₅) 260 between clads (SiO2) 250, and is irradiated from the light emission opening 240. The refractive index of the core is higher than the refractive index of the clad.

Sizes indicated in FIGS. 13A, 13B and 13C are as follows:

### W₁=100 μm

### W₂=1 μm

### W₃=1 μm

### W₄=1 μm

d=1 μm.

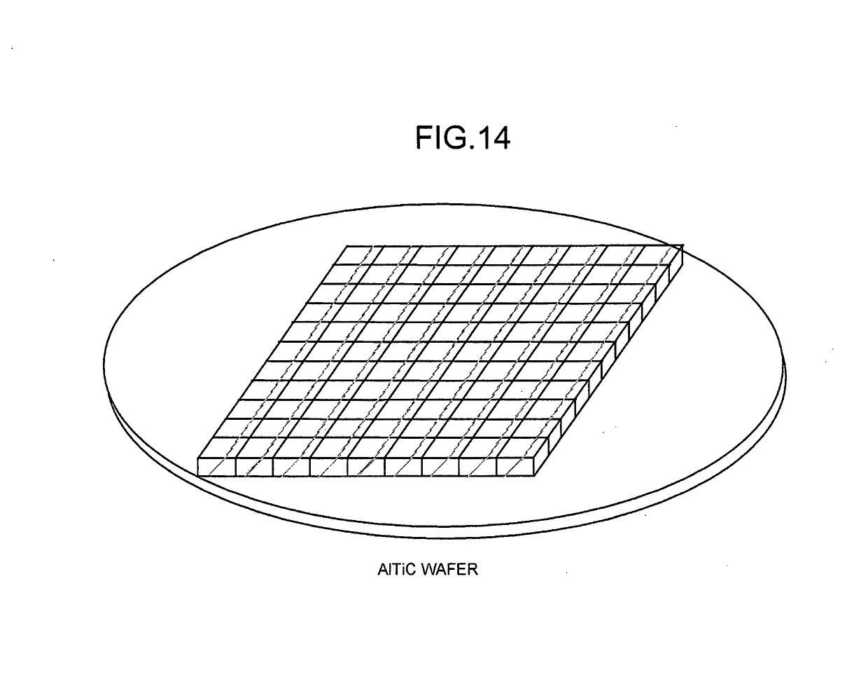

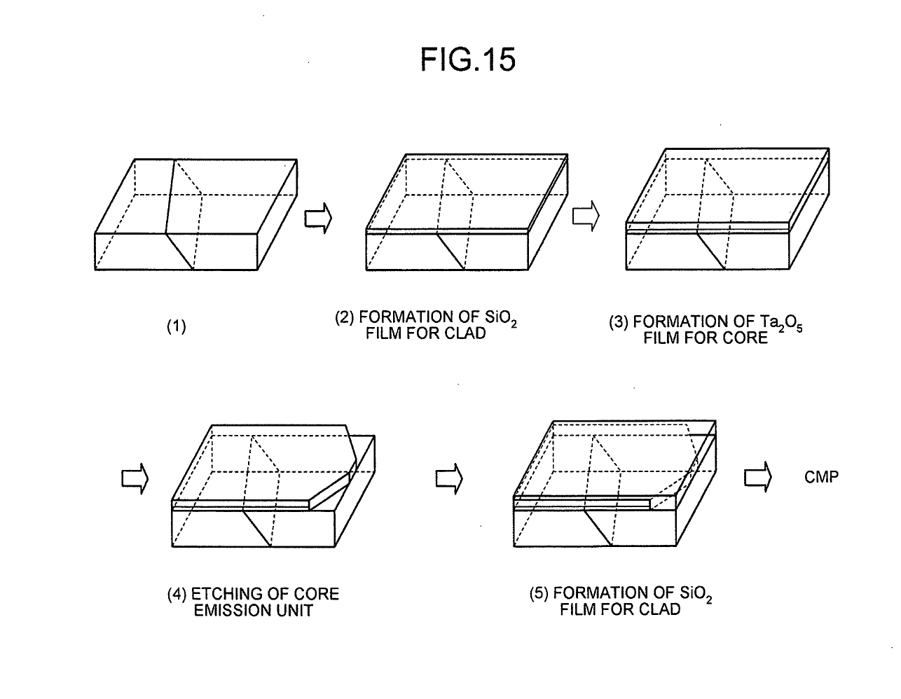

A method of manufacturing the head unit shown in FIG. 12 and FIGS. 13A, 13B and 13C is explained next. FIG. 14 and FIG. 15 are schematic diagrams for explaining the method of manufacturing the head unit shown in FIG. 12 and FIGS. 13A, 13B and 13C. As shown in FIG. 14 and FIG. 15, a silicon substrate (crystal directions <1,1,1>, etc.) is connected to an AlTiC substrate (slider material), and the connected substrate is ground to have a desired thickness. As described above, when the reproduction magnetic head is formed first, the reproduction magnetic head is formed on the AlTiC substrate (slider material), and the silicon substrate is fitted to this surface.

To form the reflection mirror 220 shown in FIGS. 13A, 13B and 13C photoresist is patterned, and wet etching is performed to form an inclined surface. When the inclined surface is manufactured in this way, a high refractive-index film through which light passes is formed. Next, to flatten the surface, chemical mechanical polishing (CMP) is conducted. The CMP process after forming the high refractive-index film can be omitted. Alternately, as shown in FIG. 14, a matrix array can be fitted to the AlTiC substrate (slider material), by forming a reflection film on a glass substrate, laminating the film in multilayer, and cutting the lamination at a slant, in a similar manner to that of manufacturing an optical head for the optical disk.

FIG. 15 depicts a further manufacturing process and depicts manufacturing of one single magnetic head. A portion of SiO₂ for clad is partially formed on the substrate having a reflection surface shown in (1), excluding the part through which light from the reflection mirror is passed ((2)). This can be easily achieved by patterning resist. Thereafter, the CMP is performed to flatten the surface. A portion of Ta₂O₅ for a core is filmed ((3)). The core emission part (the part corresponding to the light emission opening 240 shown in FIG. 12) is etched ((4)), and the SiO₂ for clad is filmed ((5)). Through the CMP, a single magnetic pole 230a is manufactured in the normal manufacturing process of a magnetic head.

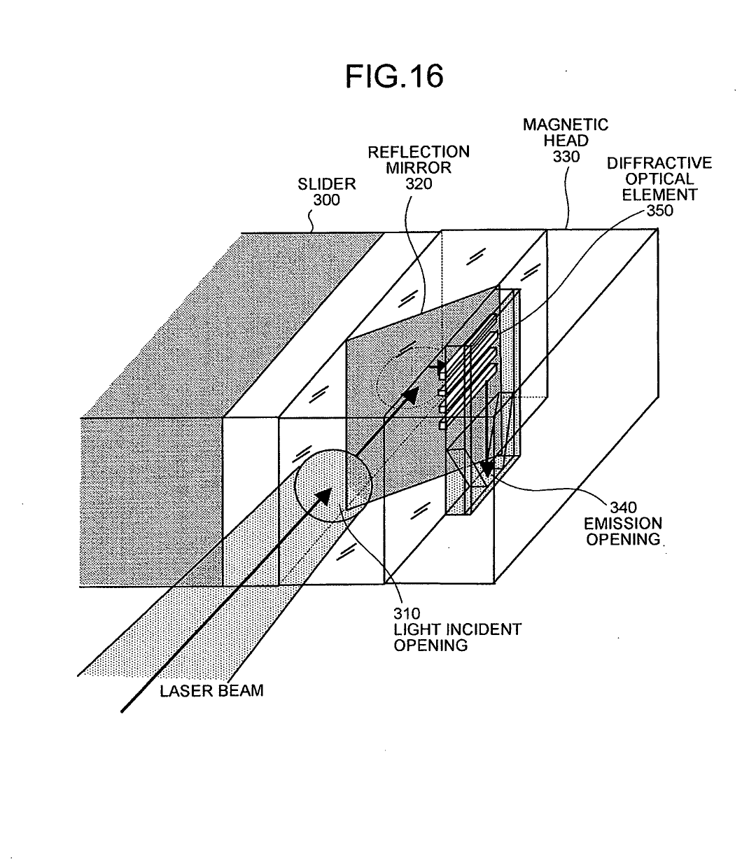

The laser beam can be also input to the core, using a diffractive optical element. FIG. 16 depicts a configuration of the head unit using a diffractive optical element. As shown in FIG. 16, this head unit includes a slider 300, and a magnetic head 330. The slider 300 has a light incident opening 310, a reflection mirror 320, and a diffractive optical element 350. A laser beam irradiated to the head unit is incident to the head from the light incident opening 310, and is reflected by the reflection mirror 320. The laser beam reflected by the reflection mirror 320 is not totally reflected by the diffractive optical element 350, and is incident to the core. The laser beam incident to the core is emitted from the emission opening 340, thereby performing thermal assist at the information recording time.

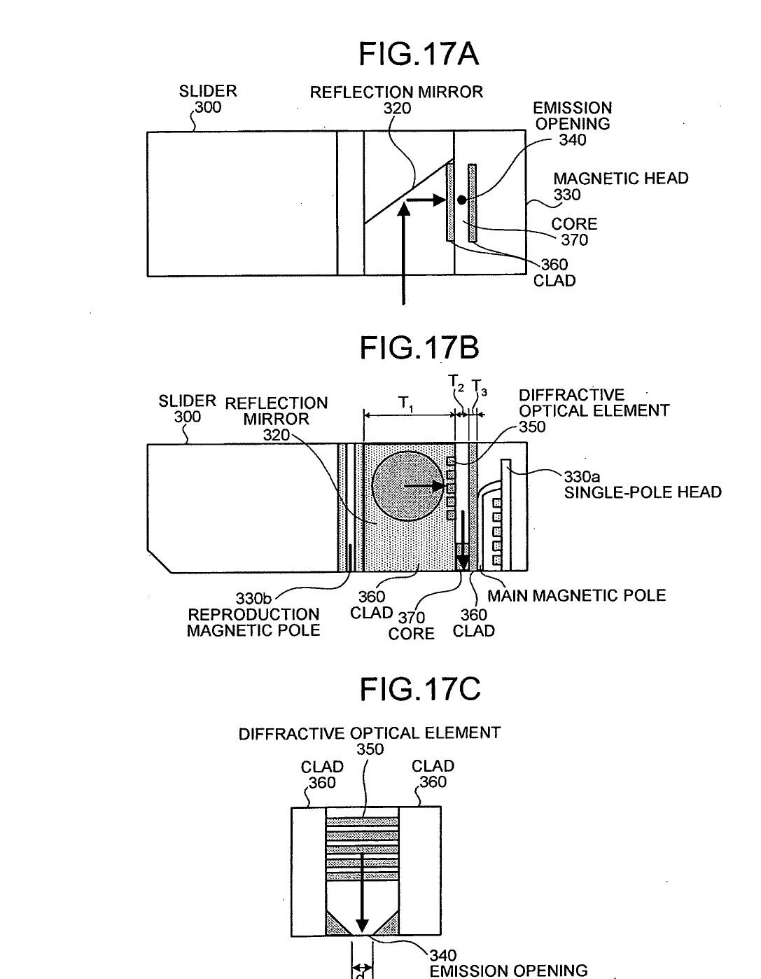

FIGS. 17A, 17B and 17C depict a detailed configuration of the head unit shown in FIG. 16. As shown in FIGS. 17A, 17B and 17C, the magnetic head 330 has a single-pole head 330a, and a reproduction magnetic head 330b. A laser beam reflected by the reflection mirror 320 is incident to a core 370 between clads 360 through the diffractive optical element 350, and is irradiated from the emission opening 340.

Sizes indicated in FIG. 17 are as follows:

### T₁=100 μm

### T₂=1 μm

### T₃=1 μm

d=1 μm.

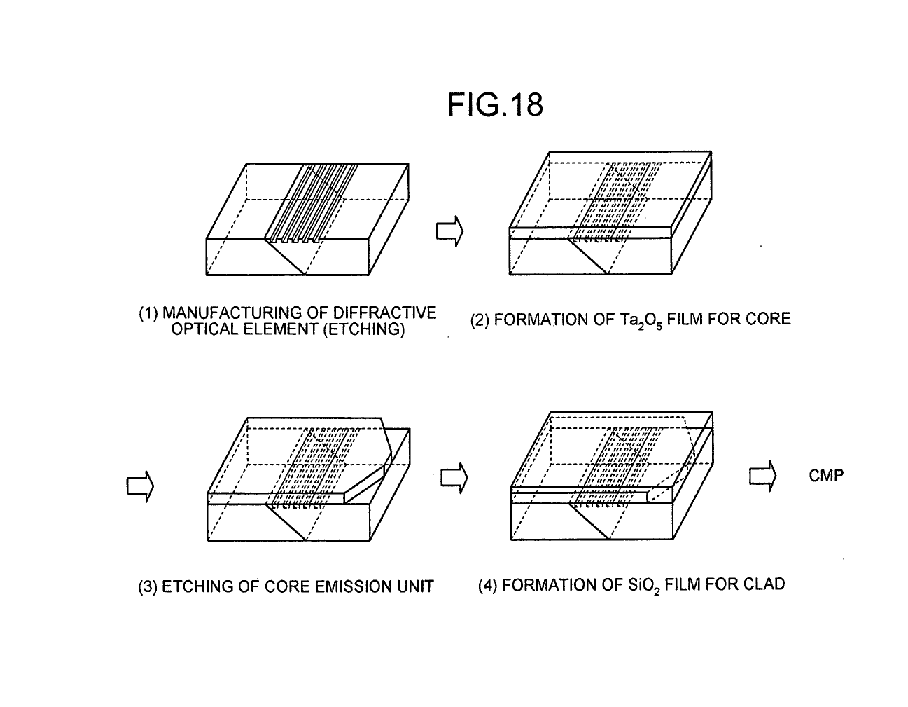

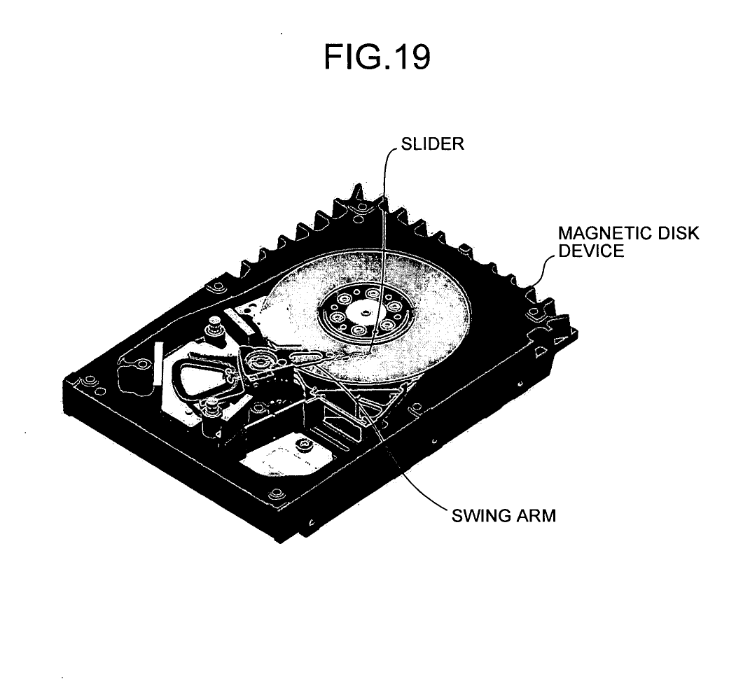

A method of manufacturing the head unit shown in FIG. 16 and FIGS. 17A-17C is explained next. FIG. 18 is a schematic diagram for explaining the method of manufacturing the head unit shown in FIG. 16 and FIGS. 17A-17C. As shown in FIG. 18, a silicon substrate is connected to an AlTiC substrate, and the connected substrate is ground to have a desired thickness. When the reproduction magnetic head is formed first, the reproduction magnetic head is formed on the AlTiC substrate (slider material), and the silicon substrate is fitted to this surface.

After the reflection mirror 320 is manufactured, the diffractive optical element 350 is manufactured by etching. The Ta₂O₅ for core is filmed, and the core emission unit (the part corresponding to the emission opening 340 shown in FIG. 16) is etched. The SiO₂ for clad is filmed, and through the CMP, a recording magnetic head is manufactured in the normal manufacturing process of a magnetic head.

As explained above, the head unit according to the present invention is manufactured simultaneously with the recording/reproducing magnetic head in the wafer processing, in a similar manner to that of manufacturing a head used in the normal magnetic head device. Therefore, the head manufacturing cost can be minimized.

As described above, according to the information recording device of the present embodiment, the LD 100 laid out at a position of a predetermined distance from the swing arm 20 outputs a laser beam. The laser beam output from the LD 100 passes the beam converter 90 and the mirror 80, and is irradiated to the spherical aberration lens 70 that generates a spherical aberration. The laser beam that passes the spherical aberration lens is incident to the light incident opening of the slider 60 at a constant angle (for example, perpendicularly), thereby performing thermal assist at the information recording time. Therefore, the problem of thermal assist attributable to the increase in the recording density of the recording medium can be solved.

According to the information recording device of the present embodiment, the LD 100 and the like are laid out at a position other than the swing arm 20, thereby performing thermal assist at the information recording time. Therefore, high-speed recording and high-speed reproduction of information are performed based on high-speed seek performed by the swing arm 20.

In FIG. 3, an optical element that makes the light intensity distribution constant, as shown in Japanese Patent Application No. H10-57003 and Japanese Patent Application No. H10-260281, can be laid out between the mirror 80 and the spherical aberration lens 70. By transmitting a laser beam through this optical element, and irradiating the transmitted laser beam to the whole surface of the spherical aberration lens 70, the laser beam can be incident in high precision to the light incident opening of the slider 60.

While the magnetic disk device having the single-pole head has been explained in the present embodiment, the present invention can be also applied to a magnetic disk device having an in-plane recording head or a phase-change-type optical disk.

The information recording device according to the present invention inputs light to the head from a position with a predetermined distance from the arm, and irradiates the light incident to the head, to the position of the recording medium where information is recorded. Therefore, the problem of thermal fluctuation can be solved, and information can be recorded onto the recording medium at a high speed by high-speed seek.

The head according to the present invention reflects the incident light, and leads the reflected light to the position of the recording medium where information is recorded. Therefore, thermal assist can be conducted efficiently.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information recording device that records information on a recording medium, by positioning a rotatable arm having a head mounted thereon for recording the information on the recording medium, the information recording device comprising:
a light input unit, disposed at a stationary position other than a position of the rotatable arm, inputting light to the head; and
an irradiating unit irradiating a position of the recording medium at which information is recorded with the light incident to the head from the light input unit.

2. The information recording device according to claim 1, wherein the recording medium includes a magnetic recording layer, and the head magnetically records information at a position of the magnetic recording layer irradiated with the light by the irradiating unit.

3. The information recording device according to claim 1, wherein the light input unit inputs light to the head at a constant incident angle.

4. The information recording device according to claim 3, wherein the light input unit inputs light to the head at a right angle to the head.

5. The information recording device according to claim 1, further comprising an aberration generating unit that generates aberration, wherein the light input unit transmits light through the aberration generating unit and inputs the transmitted light to the head.

6. The information recording device according to claim 5, wherein the aberration generating unit generates spherical aberration.

7. The information recording device according to claim 5, wherein the aberration generating unit includes a spherical aberration lens that generates spherical aberration, and an aspherical coefficient A of the spherical aberration lens is equal to or larger than 0.4 and equal to or smaller than 0.6.

8. The information recording device according to claim 5, wherein the aberration generating unit includes a plurality of spherical aberration lenses that generate spherical aberration.

9. The information recording device according to claim 7, wherein the spherical aberration lens includes an aspherical lens.

10. The information recording device according to claim 7, wherein the spherical aberration lens has only one side of a whole lens shape.

11. The information recording device according to claim 8, wherein the aberration generating unit includes an aspherical aberration lens having the same number of surfaces as that of recording surfaces of the recording medium.

12. The information recording device according to claim 5, wherein the light input unit irradiates a whole surface of the aberration generating unit with light, transmits the irradiated light through the aberration generating unit, and inputs the transmitted light to the head.

13. The information recording device according to claim 1, further comprising an optical path changing unit that changes an optical path of light incident from the light input unit to the head in accordance with a position of the head.

14. The information recording device according to claim 13, further comprising a reflection surface member provided on the head, wherein the optical path changing unit detects light intensity of light reflected from the reflection surface member and changes an optical path of the light incident from the light input unit to the head so as to maximize the light intensity.

15. The information recording device according to claim 13, wherein the optical path changing unit includes a polarization-direction changing unit that changes a polarization direction of light incident from the light input unit to the head, and a shielding unit that shields light in a predetermined polarization direction.

16. The information recording device according to claim 1, further comprising a parallel-light converting unit that converts the light incident from the light input unit to the head, to parallel light parallel with a recording surface of the recording medium.

17. The information recording device according to claim 1, further comprising a light shielding unit that shields light other than the light incident from the light input unit to the head.

18. The information recording device according to claim 1, wherein the light input unit inputs light to the head so that the light incident to the head has a predetermined beam diameter when the head is positioned at the innermost periphery of the recording medium.

19. A head for recording information on a recording medium, comprising:
a reflection surface member that reflects incident light; and
a light transmitting unit that brings the light reflected by the reflection surface member, to a position of the recording medium at which information is recorded.

20. The head according to claim 19, wherein a refractive index of the light transmitting unit is higher than a refractive index of a material in contact with the light transmitting unit.

21. The head according to claim 19, further comprising a diffractive optical element that inputs light reflected by the reflection surface, to the light transmitting unit.

22. The head according to claim 19, wherein a distance between a position of the light transmitting unit at which the light is emitted and the recording medium is larger than a distance from a bottom surface of the head to the recording medium.
